(19) United States
(12) Patent Application Publication
(10) Pub. No.: US 2009/0069271 A1
(43) Pub. Date: Mar. 12, 2009

(54) WOOD TREATMENT

(76) Inventor: Ivan Laurence Stanimiroff, Auckland (NZ)

Correspondence Address: BROOKS KUSHMAN P.C., 1000 TOWN CENTER, TWENTY-SECOND FLOOR, SOUTHFIELD, MI, 48075, US

(21) Appl. No.: 12/093,102

(22) PCT Filed: Nov. 10, 2006
(86) PCT No.: PCT/NZ2006/000291

§ 371 Date: May 8, 2008

(30) Foreign Application Priority Data
Nov. 10, 2005 (NZ) 543487

(51) Int. Cl. A01N 55/08; A01P 1/00

(52) U.S. Cl. 514/64

(57) ABSTRACT

A method of introducing boron as a boron ester into timber via a non-aqueous liquid medium. The borate ester may have the formula I: (R₁O)(R₂O)(R₃O)B where R₁ may be a C₃-C₂₀ alkyl or alkenyl group, R₂ may be a C₃-C₂₀ alkyl or alkenyl group and R₃ may be a C₃-C₂₀ alkyl or alkenyl group. The R₂ and R₃ groups may form of a four or five membered ring structures with diols or aminoalcohols to give completely substituted monomeric borates.

### FIELD OF THE INVENTION

The invention relates to the introduction of boric acid into timber by using a non-aqueous boron compound in a liquid phase.

### BACKGROUND

Pinus radiata framing timber in New Zealand was treated with a boron-based treatment using a water-based formulation. This provided protection against wood decay from borer and also provided mouldicidal coverage. This water-based treatment of boron worked well. For many years it was considered the best product for the current climate.

Changes were brought about by modern technology. The introduction of better carpentry equipment resulted in cost and time constraints being placed on the building industry. Buildings were required to be completed more quickly. The downstream effect was a quicker turnover time in the sawmills. This, along with costing constraints on air-drying methods (previous methods were too time-consuming) resulted in new requirements for the treated timber.

In addition, the industry shifted to pre-cut and pre-nailed framing. This resulted in the requirement for drier timber. Drier timber is lighter and easier to handle. The other advantage of dry timber over wet timber is that wet warps and twists as it dries. As a result, the walls have to be straightened to accommodate the prefabricated units not made on site.

The industry reacted to these changes by kiln-drying the aqueous boron-treated timber to provide dry timber. This had two significant problems:
1. Kiln-drying timber is very expensive. The additional kiln-drying step added significantly to the cost of timber.
2. Kiln-drying involves steam-based heating of the timber. This treatment leaches boron out of the timber making it difficult to obtain adequate treatment levels.

The result was the aqueous treatment was found to be inappropriate for the changed market.

The first step to resolving this problem lay in the realisation that kiln-treated timber was partially sterilised. The low moisture content of the timber inhibits the growth of the borer. This met the requirements of the regulated industry and the regulations were changed to allow kiln-dried timber to be used. This lowered the cost framing timber was available.

However, changing architectural styles, together with the evolution of new cladding systems and the design of different flashing systems, resulted in problems. The most well known of these problems was the so-called “Leaky Building Syndrome.” This was widely documented in the New Zealand media.

The “Leaky Building Syndrome” was caused by framing timber getting wet. Fungi were able to grow on and thereby caused the decay of the framing timber. This resulted in structural failure of the framing and the building.

The discovery of the Leaky Building Syndrome brought about major changes to the flashing and cladding systems. In addition, changes to the design of the buildings had to be made to allow moisture to be released from within the framing.

As another consequence of “Leaky Building Syndrome”, the law was changed to require a level of mouldicide protection in framing timber. The market met this requirement in two ways:
1. By going back to the kiln-dried boron-treated timber; and
2. By adapting a product called Low Odour Solvent Preservative (LOSP) for the framing market. LOSP was originally developed for the finger-joint moulding market.

The LOSP method uses a different active to provide the mould and pest resistance to the timber. Boron is regarded as more benign environmentally and physiologically. This is an issue when dealing with liabilities.

There is a need for an improved boron-based treatment for wood that is cost effective and provides effective mouldicide and pesticidal treatment.

Borate esters have always been around and work has been done in this area (NZ220816, NZ225153, NZ244803). There seems to be a misunderstanding of the rate of hydrolysis in timber and no-one can envisage an effective way of manufacturing the borate esters. As a consequence, developments in boron treated timber have headed towards stable aqueous soluble organic boron with mouldicide properties (NZ523288). Also there has been work done on increasing the solubility of boric acid in polar solvents.

By combining known components to design a novel and beneficial solution, it is possible to introduce boric acid into the timber as borate ester in an organic solvent.

Throughout this specification reference will be made to organoboron molecules. The nomenclature used in this specification to refer to these molecules is that recommended in the IUPAC recommendation 2 Apr. 2004, unless otherwise stated.

Specifically the boron structures with formula (RO)₃B, can collectively be called trialkyloxyborane or referred to organically as trialkyl borate esters. The structures proceeding in this text will be referred to as trialkyl borates. The cyclic structures will be referred to as borates of the starting diol, with the substitute of the third hydroxy group preceding the diol. They can also be referred to as 1,3,2 dioxabor/ane with numbers 1 and 3 representing the oxy groups and the 2 representing the boron, and the ending referring to the ring size.

### OBJECT

The object of the invention is to provide a non-aqueous boron treatment for timber for the building market with regard to H1.2, H3.1 and H2 treatment levels.

### STATEMENT OF THE INVENTION

In one aspect the invention relates to the provision of an improved formulation for incorporating boric acid into timber. Preferably the formulation includes a borate ester having the Formula I:

(RO)₃B

Where R1 may be a C3-C20 alkyl or alkenyl group, R2 is a C3-C20 alkyl or alkenyl group and R3 is a C3-C20 alkyl or alkenyl group.
R2 and R3 may form four or five membered ring structures with diols or aminoalcohols to give completely substituted monomeric borates. Borate esters suitable for use in the invention must possess the following characteristics:
1. The solubility has to be such that the required treatment concentration of boric acid equivalents needs to meet the relevant treatment standard.

By way of example, n-butyl, di-1-dodecyl borate when used to treat timber
to a H1 plus standard in New Zealand would require 1.6 kg/m³ of
boric acid equivalent (BAE) per cubic metre.

| | |
|---|---|
| Molecular weight of n-butyl, di-1-dodecyl borate | = 502.5 |
| Ratio of n-butyl, di-1-dodecyl borate/boric acid | = 502.5/61.8 |
| Therefore 1.6 kg BAE × 502.5/61.8 | = 13.0 kg of n-butyl, |
| | di-1-dodecyl borate |
| SG of n-butyl, di-1-dodecyl borate | = 0.85 |
| 13.0 kg/0.85 | = 15.3 ltrs/m³ of |
| | n-butyl, |
| | di-1-dodecyl borate |

For LOSP uptake of 35 ltrs/m³ the solubility of
n-butyl, di-1-dodecyl borate

| | |
|---|---|
| With aliphatic/aromatic solvent | = 15.3/35 × 100 |
| | = 43.7% |

2. The molecule should have a rate of hydrolysis such that it meets the technical requirement of the treatment conditions, using the relative rate of hydrolysis taken from Organoboron Chemistry, Volume I, by Howard Steinberg, Chapter 21 page 849.

By way of example Tri-dodecyl borate would be suitable. This rate of hydrolysis is gauged by comparing the U.S. Pat. No. 5,024,861, which uses a vapor treatment with tri-methyl borate. This has a relative rate of hydrolysis of 5.87×15. This molecule would be less preferable in the proposed liquid treatment system because the hydrolysis would cause over-treatment and large loss of the treatment solution. Tri-dodecyl borate has a relative rate constant of 2.77×10⁴ and is a molecule that fits the criteria and is very similar to the borate structure used in the trial. This proposed molecule has good solution stability and treatment stability.

Relative rates of hydrolysis of boric acid esters in aqueous dioxane
This table is taken from Organoboron Chemistry, Volume 1, page 849

| Ester | | Relative rate |
|---|---|---|
| Trimethyl borate | | |
| Triethyl borate | | |
| Tri-n-propyl borate | | |
| Triisopropyl borate | | |
| Tri-(1,3-dichloro-2-propyl) borate | | |
| Tri-n-butyl borate | | |
| Triisobutyl borate | | |
| Tri-(β,β,β-trichloro-t-butyl) borate | {close oversize brace} | >5.87 × 10⁵ |
| Tri-(hexylene glycol) biborate | | |
| Triphenyl borate | | |
| Tri-o-chlorophenyl borate | | |
| Tri-o-cresyl borate | | |
| Tri-(o-phenylphenyl) borate | | |
| Tri-(o-cyclohexylphenyl) borate | | |
| Tri-n-amyl borate | | 5.87 × 10⁵ |
| Tri-(octylene glycol) biborate | | 3.92 × 10⁵ |
| Tri-hexyl borate | | 2.02 × 10⁵ |
| Tri-s-butyl borate | | 1.68 × 10⁵ |
| Tri-(1-ethynylcyclohexyl) borate | | 4.29 × 10⁴ |
| Tri-n-octyl borate | | 3.67 × 10⁴ |
| Trioleyl borate | | 3.57 × 10⁴ |
| Tri-n-dodecyl borate | | 2.77 × 10⁴ |
| Tristearyl borate | | 2.71 × 10⁴ |
| Tri-2-octyl borate | | 4.33 × 10³ |
| Tri-(2-ethylhexyl) borate | | 2.77 × 10³ |
| Tri-(methylisobutylcarbinyl) borate | | 2430 |
| Tri-t-butyl borate | | 1370 |
| Tri-3-pentyl borate | | 483 |
| Tri-t-amyl borate | | 449 |
| Tri-3-heptyl borate | | 415 |
| Tri-(trans-2-phenylcylohexyl) borate | | 40.0 |
| Tri-(2-phenylcyclohexyl) borate | | 34.1 |
| Tri-(cis-2-phenylcyclohexyl) borate | | 28.2 |
| Tri-(diisobutylcarbinyl) borate | | 5.86 |
| Tri-(2,6,8-trimethyl-4-nonyl) borate | | 4.83 |
| Tri-(2-cyclohexyl) borate | | 3.67 |
| Tri-(dicyclohexylcarbinyl) borate | | 1 |

In a further related aspect the invention includes a preservative solution for timber including the borate ester of the invention dissolved in a solvent.

Preferably, any aromatic/aliphatic solvent or mixture that will dissolve the borate ester at the required concentration for compliance treatment of the timber would be suitable.

In a further related aspect the invention provides a process of introducing boric acid into timber, to provide a preservative/flame retardant in any manner that ensures uptake of sufficient borate ester to meet the regulatory requirements for boric acid equivalent needed.

Preferably the Low Odour Solvent Preservative method is used to introduce the preservative solution to the wood.

More preferably, the method uses the exact same process as the current LOSP. Timber. The only difference is the treatment solution and the treatment cycle to attain the required uptake; although this varies depending on the density of the timber and the size and treatment plant design.

The basic outline for LOSP treated timber is:
1. Kiln-dried timber is placed into the treatment vessel.
2. A vacuum is pulled in the cylinder; this removes any air that is inside the lattice of the timber. The amount of vacuum and length of time are all subject to trial and error to meet the uptake requirement of the timber.
3. The cylinder is flooded with a solution containing the borate ester of the present invention; and after a period of time the cylinder is drained of the treatment solution.
4. A vacuum is pulled again removing substantial amounts of the treatment solution that is remaining in the timber.

Preferably, approximately 1.6 kg, 0.8 kg and 4.0 kg of boric acid equivalent will remain in a cubic metre of wood (using the density of the timber as 400 kg/m³), to meet the New Zealand requirements for H1.2, H3.1 and H2 applications.

There are many different treatment variations based on this outline; all designed to give uniform treatment for each piece of timber.

In a further related aspect the invention comprises a flame retardant treatment for wood.

The process for imparting flame retardant in the wood is similar to that detailed above for the preservative treatment. However a greater final concentration of boric acid equivalent per cubic metre of wood would be required.

### BRIEF DESCRIPTION OF THE DRAWINGS

FIG. 1 has molecules/mixture of molecules arranged in theoretical molecular weight.

In FIG. 2, the molecular weight is compared with specific gravity using the arranged number system.

In FIG. 3, the molecular weight is compared with the solubility using the arranged number system.

### DETAILED DESCRIPTION

Traditionally, boron has been used to treat timber to make it resistant to mould and borer. In general, aqueous solutions of a boron compound are used. These solutions involve dissolving a boron compound such as boric acid in water. However this requires an additional drying step, which is very costly. In addition the drying process leaches boron from the timber. This leads either to:
(a) A requirement for an initial over-supply of boron;
(b) The provision of an insufficient amount of boron compound for effective treatment of the timber

The borate ester reacts with water to form boric acid. In general, the moisture content in dried wood is sufficient to lead to hydrolysis (breakdown) of the ester to form boric acid. It is the boric acid that provides the mouldicide and pesticidal activities.

Preferred borate esters are set out above.

Those skilled in the art will be able to prepare the ester using standard chemical techniques; however, preparation techniques found to be particularly efficacious, are shown.

### Properties and Synthesis

The definition of the borate esters is a borate ester having the formula I:

(RO)₃B

Where R1 is a C3-C20 alkyl, R2 is a C3-C20 alkyl and R3 is a C3-C20 alkyl.

R2 and R3 may form four or five membered ring structures with diols or aminoalcohols to give completely substituted monomeric borates. It should be noted that the longer chain alcohols are not commercially bought as pure substances but mixtures of the different chain lengths.

In order to understand the properties required of the borate esters, a range of molecules were made up to cover the definition range and their properties assessed. The molecules were synthesised by various methods with the view to find their properties as well as using the information gained for upscaling to manufacturing. The borate esters synthesised are either a mixture of borate esters, each boron containing the same alcohol; or a synthesis with mixed alcohols on each boron. For the purpose of the patent the properties are more important than the definitive structure.

The table below contains the range of molecules/mixture of molecules used to display the physical and chemical properties required for the invention.

| | | Molecular | Molecular | | | | |
|---|---|---|---|---|---|---|---|
| Sample No | | Formula | Weight | SG | Phase@STP | Solubility | BAE |
| 1 | 24 | C3BOC2O | 130 | 0.974 | liquid | 83 | 296.6 |
| 2 | 25 | C4BOC2O | 144 | 0.961 | liquid | 83 | 278 |
| 3 | 30 | C3BOC3O | 158 | 0.974 | liquid | 83 | 290.5 |
| 4 | 26 | C8BOC2O | 200.1 | 0.92 | liquid/milky | 83 | 250 |
| 5 | 2 | C4OB(OC3)2 | 202.1 | | liquid | 83 | 253 |
| 6 | 1 | C4C4C3 | 216.1 | 0.858 | liquid | 83 | 234 |
| 7 | 33 | (C4O)BOC2NH | 217.08 | 0.948 | liquid/yellow | 83 | 165.9 |
| 8 | 3 | (C4C4C4)3B | 230.1 | 0.854 | liquid | 83 | 191.6 |
| 9 | 4 | C4C4C4-2 | 230.1 | 0.85 | liquid | 83 | 180 |
| 10 | 5 | C4C4C4iso | 230.1 | 0.847 | liquid | 83 | 163.3 |
| 11 | 27 | C12BOC2O | 256.24 | 0.897 | solid/liquid | 83 | 136 |
| 12 | 6 | C4C4C5 | 258.3 | 0.846 | liquid | 83 | 157.2 |
| 13 | 31 | C12BOC3O | 270.24 | 0.964 | liquid | 83 | 126.7 |
| 14 | 7 | C4C4C8 | 286.2 | 0.85 | liquid | 83 | 124.2 |
| 15 | 28 | C16BOC2O | 312.34 | 0.835 | solid | 50 | 125 |
| 16 | 8 | C3C3C12 | 314.34 | 0.865 | liquid | 83 | 148 |
| 17 | 9 | (C4 iso)2BC12 | 314.34 | 0.86 | liquid | 83 | 158 |
| 18 | 34 | (C8O)BOC2NH | 329.8 | 0.905 | liquid/yellow | 83 | 106.6 |
| 19 | 29 | C18BOC2O | 340.49 | 0.853 | solid | 10 | 126 |
| 20 | 10 | C4C4C12 | 342.34 | 0.864 | liquid | | 164 |
| 21 | 36 | (C8O)BOC3NH | 343.31 | 0.92 | liquid | 83 | 110.6 |
| 22 | 32 | C18BOC3O | 354.49 | 0.86 | solid | 10 | 126.7 |
| 23 | 17 | C3C3C16 | 370.44 | | | | |
| 24 | 18 | C3C3C16 | 370.44 | 0.85 | solid | | 93.3 |
| 25 | 12 | C4C8C12 | 390.64 | 0.85 | liquid | 83 | 100 |
| 26 | 16 | C4C4C16 | 398.4 | 0.845 | liquid | 83 | 80 |
| 27 | 11 | C8C8C8 | 398.44 | 0.828 | solid | 62.5 | 103 |
| 28 | 19 | C4C4C18 | 426.59 | 0.82 | solid | 25 | 97.6 |
| 29 | 20 | C4C5C═18 | 438.59 | 0.857 | liquid | 83 | 92.1 |
| 30 | 15 | C4C12C12 | 454.58 | 0.85 | liquid | 83 | 108 |
| 31 | 13 | C4C8C18 | 482.69 | 0.836 | solid | 44.4 | 84 |
| 32 | 14 | (C12O)3B | 566.82 | 0.833 | solid/liquid | | 90.9 |
| 33 | 35 | (C18O)BOC2NH | 610.06 | 0.8 | solid/yellow | 10 | 85 |
| 34 | 23 | (C18O)2BOC4 | 623.08 | 0.843 | solid | 5 | 45.1 |
| 35 | 37 | (C18O)BOC3NH2 | 624.09 | 0.848 | solid | 5 | 83 |
| 36 | 21 | (C18O═)3B | 813.27 | 0.866 | liquid | 83 | 83.3 |
| 37 | 22 | (C18O)3B | 819.57 | 0.812 | solid | <2.5 | 43.6 |

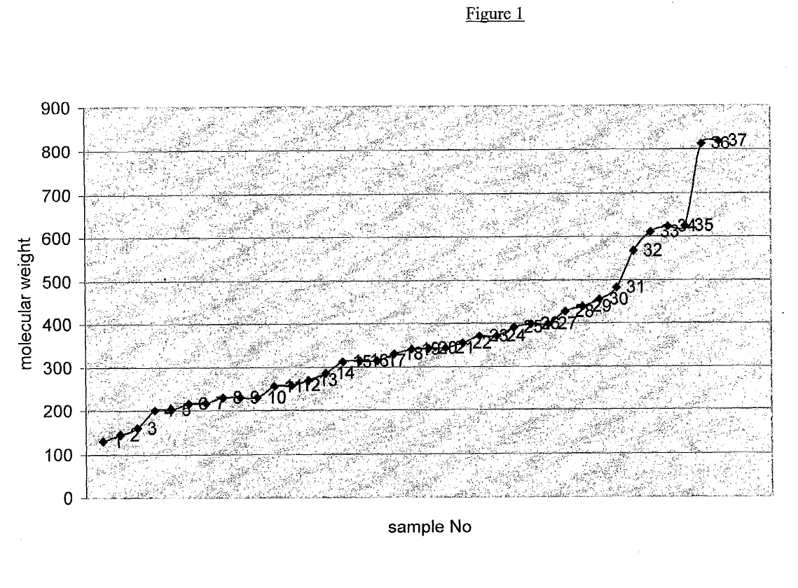

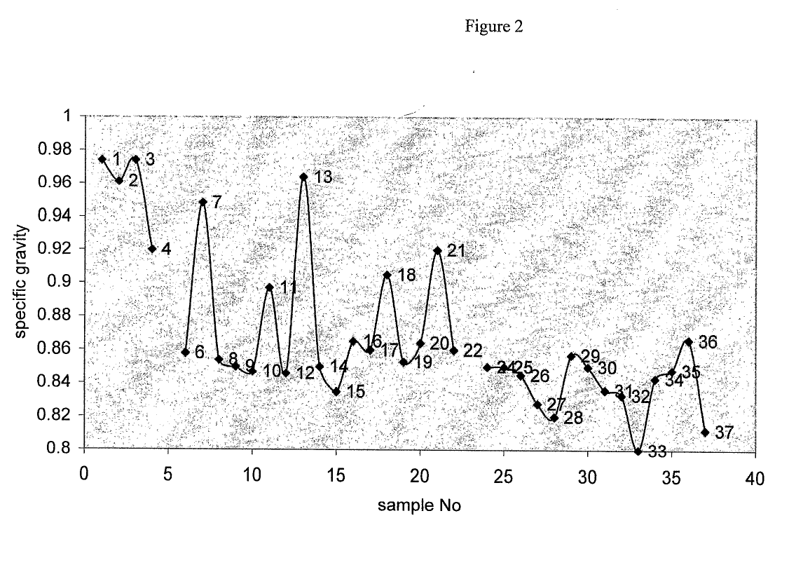

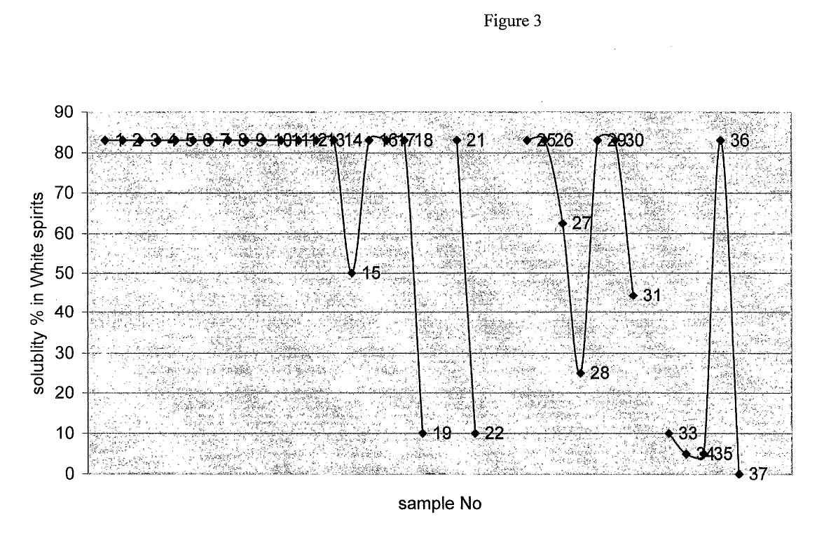

FIGS. 1-3 show the results of the characteristics of these compounds.

The samples used synthesis grade reagents to gain a better understanding of the properties. The commercial product will be based on the best commercial price. As a result of this, the alcohols would probably be a mixture of different molecular weight alcohols. An example would be alcohol grade made from coconut oil, which has a range from C₈ to C₁₈ including oleyl alcohol. Where possible, the most commercially available alcohols within the range have been used. The information gained from the synthesis of the molecules show the properties of all the possible molecules that can be used within the scope of the patent.

### Rate of Hydrolysis

The rate of hydrolysis has to be taken into account with these borate esters. If the rate of hydrolysis is too fast there will be difficulties with controlling the concentration of the boron in the final product. Stability for the storage of the product will also be compromised.

Hydrolysis data from Steinberg & Brotherton was used to compare the rate of hydrolysis in a three-dimensional system with a pseudo two-dimensional system.

From page 845, Volume 1, Steinberg & Brotherton, Organoboron Chemistry.

TABLE 21-1
Base catalysed rate of hydrolysis of boric acid esters of straight chain
primary alcohols in 60% aqueous dioxane at 21°

| Esters | Half-life(sec.) |
|---|---|
| Trimethyl borate | Too fast to measure |
| Triethyl borate | Too fast to measure |
| Tri-n-propyl borate | Too fast to measure |
| Tri-n-butyl borate | Too fast to measure |
| Tri-n-amyl borate | 1.0 |
| Tri-n-hexyl borate | 2.9 |
| Tri-n-octyl borate | 16.0 |
| Tri-n-dodecyl borate | 21.3 |
| Tristearyl borate | 21.7 |

A pseudo three-dimensional test was made by taking 10 mls of distilled water and placing in a 19 mm diameter test tube. 20 mls of sample was then layered on the water; the rate of hydrolysis was then measured. This was done by taking 2 ml samples from the test tube over time, refluxing and titrating the 2 ml samples to get the concentration. The test was with n-butyl di-n-propyl borate, which should have similar kinetic properties to tri-n-propyl borate and tri-n-butyl borate. The test was also done with tri-n-octyl borate.

| | | |
|---|---|---|
| n-butyl di-n-propyl borate | half-life | 6.5 hours |
| Tri-n-butyl borate | half-life | 89 hours |

It can be seen that there is an exponential difference in the half-life when changing the conditions of hydrolysis. For the commercial method of which the patent covers, the hydrolysis rate is slow enough to give consistent uptake of product in the timber and provide stable solution concentration.

Although it is not covered in the conditions of the patent, it should be noted that the understanding of the rate of hydrolysis within the lattice of the timber is important if the hydrolysis of the borate is to deliver the required amount of boron to be effective as a mouldicide/pesticide.

### EXAMPLE 1

Two different borates were prepared in the treatment solution; n-butyl,di-1-dodecyl borate (or n-butoxy,di-1-dodecoxy borane which is the inorganic name) and 1-dodecyl,1,3 propylene glycol borate (or n-butoxy,1,3,2dioxborinane which is the inorganic name).

The n-butyl,di-1-dodecanyl borate was prepared by adding in equimolar weights at a ratio 2 moles of 1-dodecanol with 1 mole boric acid.

These were then placed in a boiler flask with a Dean Stark apparatus attached. This was heated until 2 equimolar ratio of water was removed. This was evident by observing the scale on the Dean Stark apparatus. Once the water had been removed, the solution was left to cool to approximately 70° C. Then 1 mole weight equivalent of n-butanol was added. This was then heated until 1 mole equivalent of water was removed. After this the solution was removed from the boiler flask.

1-dodecyl, 1,3 propylene glycol borate was prepared by placing 1 mole equivalents of boric acid and propyl glycol into a boiler flask with a Dean Stark apparatus attached. This was then heated until 2 equimolar amount of water was removed. This was then cooled to approximately 70° C. Then 1 mole equivalent of 1-dodecanol was added to the boiler flask and heated until 1 equimolar amount of water was removed. The solution was then removed from the boiler flask and left to cool.

5 batches of n-butyl di-1-dodecyl borate yielded approximately 250 mls of product at a time. 2 batches of 1-dodecyl,1,3 propylene glycol borate yielded approximately 250 mls a batch. This gave a total of approximately 1700 mls when added together. This was then diluted 50/50 with Fuelite giving a total of 2.4 litres of solution for treating. Fuelite is a commercial aliphatic/aromatic solvent available.

### Treatment of Timber Samples

Clear 45 mm×45 mm lengths of untreated mainly sapwood were selected and cut into 200 mm lengths, then end sealed with PVA glue.

A treatment vessel was then constructed with a volume of 7 litres, using a venturi to pull a vacuum. The vessel had a vacuum gauge and valve to control an inlet-outlet pipe.

4 pieces of the prepared timber samples were placed in the treatment vessel at a time.

### Treatment 1

With the treatment samples in the cylinder; a vacuum of −45 kpa for 5 minutes was pulled.

The vessel was then flooded with treatment fluid for 5 minutes.

Then the treatment fluid was emptied from the cylinder.

A vacuum of −70 kpa was then pulled for ½ an hour.

Only two samples were recovered.

| Sample weights before: | 224 g | 177 g |
|---|---|---|
| Sample weights after: | 231 g | 185 g |
| | 7 | 8 |

average = 7.5 g

SG of the treatment fluid was 0.77

| | |
|---|---|
| Average volume of the treatment fluid | = 7.5 g/0.77 |
| | = 9.74 mls or 9.74 × 10⁻³ ltrs |
| Volume of the timber samples | = 0.2 m × 0.045 m × 0.045 m |
| | = 4.05 × 10⁻⁴m³ |
| Uptake in lts/m³ | = 9.74 × 10⁻³/4.05 × 10⁻⁴m³ |
| | = 24.0 |

### Treatment 2

With the treatment samples in the cylinder; a vacuum of −70 kpa for 5 minutes was pulled.

The vessel was then flooded with treatment fluid for 5 minutes.

Then the treatment fluid was emptied from the cylinder.

A vacuum of −85 kpa was then pulled for ½ an hour.

### Four Samples

| Sample weights before: | 214 g | 227 g | 172 g | 178 g |
|---|---|---|---|---|
| Sample weights after: | 240 g | 251 g | 196 g | 202 g |
| | 26 | 24 | 24 | 24 |

Average = 24.5 g

SG of the treatment fluid was 0.77

| | |
|---|---|
| Average volume of the treatment fluid | = 24.5 g/0.77 |
| | = 31.8 mls or 31.8 × 10⁻³ ltrs |
| Volume of the timber samples | = 02.m × 0.045 m × 0.045 m |
| | = 4.05 × 10⁻⁴ m³ |
| Uptake in lts/m³ | = 31.8 × 10⁻³/4.05 × 10⁻⁴ m³ |
| | = 78.6 |

### Calculation of BAE of Treated Timber

Calculation of boron in treated samples are measured as the amount of boric acid in the timber or boric acid equivalent (BAE)

A sample from treatment 2 was taken with the original weight of 178 g and final weight of 202 g.

This gave the approximate uptake of 78.6 ltr/m³

This sample was then cut in half and a thin slice was taken and chopped in small pieces. From these treated wood samples, approximately 0.25 g (only measured to 2 decimal places) of wood chips were measured out twice. These were then refluxed with 100 mls of water in a boiler flask for 2.5 hours; after which they were titrated using an adapted method from A.I Vogel “Textbook of Quantitative Chemical Analysis”, 3^{rd} Edition, pg 252.

| | | | |
|---|---|---|---|
| Results: | Titration sample | 1: 2.6, 2.8, 2.6, 2.4, 2.7(mls) | average 2.62 |
| | | 2: 2.5, 2.6, 2.8(mls) | average 2.63 |

5 mls of the 100 ml H₃ BO₃ was titrated with 0.01 m NaOH
Taking the titration valve as 2.6 mls

| | |
|---|---|
| No of moles of BAE in 5 mls | = 2.6 mls × .01 × 1 × 10⁻³ |
| | = 2.6 × 10⁻⁵ |
| Mr H₃ B0₃ = 61.4 | |
| No of moles of BAE in 100 mls | = 2.6 × 10⁻⁵ × 20 |
| | = 5.24 × 10⁻⁴ |
| Weight of the sample(g) | = 5.24 × 10⁻⁴ × 61.8 |
| in 100 mls | = 0.032 g |
| Volume timber in 0.25 g | = 2.5 × 10⁻³/400 |
| | = 6.25 × 10⁻⁶ |
| Taking the standard density of | = 0.032 × 10⁻³ g/6.25 × 10⁻⁶ m³ |
| 400 kg/m³ | = 5.12 kg/m³ |
| Converting back to solution strength | = 5.12 kg/m³/78.6 ltrs/m³ |
| | = 0.065 kg/ltrs or 65.0 g/ltrs or |
| | 65.0 g/1000 mls |

### Theoretical Concentration

| | |
|---|---|
| Molecular weight of n-butyl di-1-doceyl borate | = 502.5 |
| Molecular weight of 1-doceyl borate,1,3 propylene glycol borate | = 318.24 |
| Ratio of n-butyl di-1-doceyl borate with boric acid | = 61.4/502.5 |
| Ratio of 1-doceyl borate,1,3 propylene glycol borate | = 61.4/318.24 |
| Weight of n-butyl di-1-doceyl borate with boric acid in 1700 mls | = 1200 mls × 0.85 |
| | = 1020 g |
| Weight of 1-doceyl borate,1,3 propylene glycol borate in 1700 mls | = 500 × 0.80 |
| | = 400 g |
| Amount of boric acid equivalent | = 1020 × 61.8/502.5 + 400 × 61.8/318.24 |
| | = 203.12 g in 1700 mls |
| | = 203.12/1700 mls × 1000 |
| | = 119.3 g/1000 mls |
| Final solution was diluted 50/50 with fuelite | = 119.3/2 = 59.7 g/1000 mls |

There is enough agreement in the theoretical results versus the actual results for proof of concept.

The present invention is advantageous as it provides a solution able to treat timber using existing application methods, to provide effective mouldicidal and pesticide and flame retardant activity. Use of an intermediate in organic solution is a novel approach, which delivers the boric acid into the timber by hydrolysis.

### Treatment Trials

Requirements: 150 litre open top drum
3 phase heating element
130-litre treatment plant, able to pull −85 kpa
Untreated Pinus radiata timber with dimensions (m) of 0.09×0.045 and average moisture content of 11.2% (measured with a Carrel & Carrel moisture meter)

### Trial 1

To make (C₄ OBOCO)1-n-butyl, 1,3 propylene glycol borate.

The following materials and weights were required:

| | |
|---|---|
| H₃BO₃ | 21.2 kg |
| n-C₄OH | 36.0 kg |
| White spirits | 42.3 kg + 20 kg (for azeotrope & dilution) |
| Propyl glycol | 26.0 kg |

C₄OH+white spirits+H₃BO₃ were heated together until a temperature of 110° c. was reached; the heat was then turned off. The solution was left to cool. Upon reaching a temperature of 50° c., white spirits+n-C₄OH were added. This was then heated until only residue solid was left in the bottom of the heating vessel and the solution was transparent.

This was then left to cool; it was then diluted with 20 litres and titrated for boron.

The titration gave a boric acid equivalent (BAE) of 147.0 g/l.

### Treatment

Pinus radiata timber was selected visually so that mainly sapwood was obtained. 20 pieces were cut with the dimensions 0.09×0.045×0.9 metres. This timber was then end sealed with PVA glue.

The timber was then weighed and placed in the treatment vessel.

A vacuum of − 85 Kpa for 60 minutes
within the treatment vessel
The vessel was then flooded with
treatment solution for 30 minutes. Then
the treatment vessel was drained of the
treatment solution.
Then a vacuum of −25 Kpa was pulled
in the treatment vessel for 10 minutes.
After 10 minutes the vacuum was
released and the timber removed and
weighed.

Treatment trial uptakes
Trial 1 C4OBOC3O

| | | | | | average moisture |
|---|---|---|---|---|---|
| | | | | | content 11.2% |
| | | | | | volume of |
| | | | | uptake | timber 0.0036 m3 |
| | weight | weight | uptake | (l/m3 w/w % | SG of solution 0.88 |
| | before | after | (g) | BAE | BAE 147.4 g/l |
| 1 | 1758 | 2189 | 431 | 153.93 | |
| 2 | 1786 | 2238 | 452 | 161.43 | |
| 3 | 1656 | 1918 | 262 | 93.57 | |
| 4 | 1794 | 2038 | 244 | 87.14 | |
| 5 | 1766 | 2002 | 236 | 84.29 | |
| 6 | 1680 | 1905 | 225 | 80.36 | |
| 7 | 1838 | 2155 | 317 | 113.21 | |
| 8 | 1654 | 1812 | 158 | 56.43 | |
| 9 | 1788 | 1994 | 206 | 73.57 | |
| 10 | 1766 | 2302 | 536 | 191.43 | |
| 11 | 1688 | 2099 | 411 | 146.79 | |
| 12 | 1574 | 1981 | 407 | 145.36 | |
| 13* | 1712 | 2059 | 347 | 123.93 | |
| 14 | 1574 | 1766 | 192 | 68.57 | |
| 15 | 1738 | 2165 | 427 | 152.50 | |
| 16* | 1838 | 2172 | 334 | 119.29 | |
| 17 | 1664 | 1882 | 218 | 77.86 | |
| 18 | 1706 | 2465 | 759 | 271.07 | |
| 19 | 1606 | 2000 | 394 | 140.71 | |
| 20 | 1644 | 2064 | 420 | 150.00 | |

| | |
|---|---|
| average uptake (L/m3) | 124.572 |

Two samples were cut up and tested for boric acid equivalent content (BAE).

Using method described previously (pg 17)

Sample 13 uptake weight 347 g
Sample 16 uptake weight 334 g
Sample 13 weight of sample for titration 6.45 g
Sample 16 weight of sample for titration 9.86 g

Using SG of 0.88, average moisture content 11.2% (0.888)

Dilution of sample 13 was weighed, diluted to 100 ml, 10 ml taken and titrated. Dilution for sample 16 was weighed, diluted to 1000 ml, 5 mls taken and titrated.

Sample 13, titration average was 30 mls. This gave a concentration of 3.2% m/m. The m/m % from uptake is 123.93 l/m3×0.149 kg/l/400×100 kg=4.6% m/m.

Sample 16, titration average was 4.0 mls. This gave a concentration of 5.0% m/m. The m/m % from uptake is 119.29 l/m3×0.149 kg/l/400×100 kg=4.4% m/m.

### Trial 2

Using (C₄ OBOCO)1-n-butyl, 1,3 propylene glycol borate.

Pinus radiata timber was selected visually so that mainly sapwood was obtained. 20 pieces were cut with the dimensions 0.09×0.045×0.9 metres. This timber was then end sealed with PVA glue.

The timber was then weighed.

This timber was then dipped for 2 minutes in the treatment solution, then drained of excess solvent and re-weighed.

Treatment trial uptakes
Trial 2

| | | | | | average moisture |
|---|---|---|---|---|---|
| | | | | | content 11.2% |
| | | | | | volume of |
| | | | | uptake | timber 0.0020 m3 |
| | weight | weight | uptake | (l/m3 w/w % | SG of solution 0.88 |
| | before | after | (g) | BAE | BAE 149.0 g/L |
| 1 | 1116 | 1133 | 17 | 6.07 | 3.4 |
| 2 | 968 | 983 | 15 | 5.36 | 3.0 |
| 3 | 1027 | 1048 | 21 | 7.50 | 4.3 |
| 4 | 1038 | 1071 | 33 | 11.79 | 6.7 |
| 5 | 1002 | 1022 | 20 | 7.14 | 4.1 |
| 6 | 988 | 1001 | 13 | 4.64 | 2.6 |
| 7 | 966 | 978 | 12 | 4.29 | 2.4 |
| 8 | 971 | 985 | 14 | 5.00 | 2.8 |
| 9 | 1081 | 1104 | 23 | 8.21 | 4.7 |
| 10 | 1008 | 1026 | 18 | 6.43 | 3.7 |

| | |
|---|---|
| average uptake(L/m3) | 3.8 |

Two samples were cut up and tested for boric acid equivalent content (BAE).

Using method described previously (pg 17)

Sample 5 uptake weight 20 g
Sample 9 uptake weight 23 g
Sample 5 weight of sample for titration 6.16 g
Sample 9 weight of sample for titration 3.99 g

Using SG of 0.88, average moisture content 11.2% (0.888)

Dilutions of sample 5&9 were weighed, diluted to 100 ml, 10 ml taken and titrated.

Sample 5 titration average was 1.8 mls. This gave a concentration of 0.20% m/m. The m/m % from uptake is 7.14 l/m3×0.149 kg/l/400×100 kg=0.26% m/m.

Sample 9 titration average was 1.9 mls. This gave a concentration of 0.30% m/m. The m/m % from uptake is 8.2 l/m3×0.149 kg/l/400×100 kg=0.30% m/m.

### Trial 3

Using (C₄ OBOCO)1-n-butyl,1,3 propylene glycol borate. This was then diluted with white spirits to give an approximate solution strength of 130 g/l BAE.

### Treatment

Pinus radiata timber was selected visually so that mainly sapwood was obtained. 20 pieces were cut with the dimensions 0.09×0.045×0.9 metres. This timber was then end sealed with PVA glue.

The timber was then weighed and placed in the treatment vessel.

Treatment trial uptakes
Trial 1

| | | | | | average moisture |
|---|---|---|---|---|---|
| | | | | | content 11.2% |
| | | | | | volume of |
| | | | | uptake | timber 0.0036 m3 |
| | weight | weight | uptake | (l/m3 w/w % | SG of solution |
| | before | after | (g) | BAE | 0.85 BAE 116 g/l |
| 1 | 1879 | 1988 | 109 | 38.93 | |
| 2 | 1893 | 1969 | 76 | 27.14 | |
| 3 | 2008 | 2144 | 136 | 48.57 | |
| 4 | 1675 | 1824 | 149 | 53.21 | |
| 5 | 1676 | 1822 | 146 | 52.14 | |
| 6 | 1918 | 2047 | 129 | 46.07 | |
| 7 | 1693 | 1817 | 124 | 44.29 | |
| 8 | 1927 | 2039 | 112 | 40.00 | |
| 9 | 1729 | 1799 | 70 | 25.00 | |
| 10 | 2153 | 2307 | 154 | 55.00 | |
| 11 | 2007 | 2174 | 167 | 59.64 | |
| 12 | 1788 | 1899 | 111 | 39.64 | |
| 13 | 1596 | 1686 | 90 | 32.14 | |
| 14 | 1794 | 1848 | 54 | 19.29 | |
| 15 | 1890 | 1956 | 66 | 23.57 | |
| 16 | 1634 | 1686 | 52 | 18.57 | |
| 17 | 1590 | 1694 | 104 | 37.14 | |
| 18 | 1584 | 1689 | 105 | 37.50 | |
| 19 | 1666 | 1725 | 59 | 21.07 | |
| 20 | 1704 | 1755 | 51 | 18.21 | |

| | |
|---|---|
| average uptake (L/m3) | 36.856 |

A vacuum of − 85 Kpa for 5 minutes
within the treatment vessel
The vessel was then flooded with
treatment solution for 5 minutes. Then
the treatment vessel was drained of the
treatment solution.
Then a vacuum of −85 Kpa was pulled
in the treatment vessel for 30minutes.
After 30 minutes the vacuum was
released and the timber removed and
weighed.

Two samples were cut up and tested for boric acid equivalent content (BAE).

Using method described previously (pg 17)

Sample 12 uptake weight 111 g
Sample 18 uptake weight 105 g
Sample 12 weight of sample for titration 8.75 g
Sample 18 weight of sample for titration 5.93 g

Using SG of 0.88, average moisture content 11.2% (0.888)

Dilutions of samples 12&16 were weighed, diluted to 100 ml, 10 mls taken and titrated.

Sample 12 titration average was 11.2 mls. This gave a concentration of 0.89% m/m. The m/m % from uptake is 39.4°/m3×0.116 kg/l/400 kg×100=1.1% m/m.

Sample 18 titration average was 6.7 mls. This gave a concentration of 0.79% m/m. The mm % from uptake is 37.5 l/m3×0.116 kg/l/400 kg×100=1.1% m/m.

### Trial 4

To make (C₁₆O)₂BOC₄, di hexadecanyl,n-butyl borate

| | |
|---|---|
| H₃BO₃ | 2.4 kg |
| n-C₁₆OH | 19.0 kg |
| n-C₄OH | 4.1 kg |
| White spirits | 1.82 kg (for azetrope) |

H₃BO₃+n-C₁₆ OH were added together and heated. This was heated until 134° c.; the heat was then turned off and left to cool.

Once the temperature had dropped below 80° c., the white spirits and butanol mix was added. This was heated until 110° c., then left to cool.

This was then diluted with 35 litres of white spirits and 35 litres of SAE 30/40 mineral oil.

### Treatment

Pinus radiata timber was selected visually so that mainly sapwood was obtained. 20 pieces were cut with the dimensions 0.09×0.045×0.9 metres. This timber was then end sealed with PVA glue.

The timber was then weighed and placed in the treatment vessel.

A vacuum of − 45 Kpa for 5 minutes
within the treatment vessel
The vessel was then flooded with
treatment solution for 5 minutes. Then
the treatment vessel was drained of the
treatment solution.
Then a vacuum of −85 Kpa was pulled
in the treatment vessel for 30 minutes.
After 30 minutes the vacuum was
released and the timber removed and
weighed.

Treatment trial uptakes
Trial 1

| | | | | | average moisture |
|---|---|---|---|---|---|
| | | | | | content 11.2% |
| | | | | | volume of |
| | | | | | timber 0.0036 m3 |
| | weight | | | | SG of solution |
| | before | weight after | uptake (g) | uptake (l/m3 | 0.81 BAE 27 g/l |
| 1 | 1830 | 1863 | 33 | 11.79 | |
| 2 | 1706 | 1741 | 35 | 12.50 | |
| 3 | 1687 | 1727 | 40 | 14.29 | |
| 4 | 1670 | 1710 | 40 | 14.29 | |
| 5 | 1600 | 1643 | 43 | 15.36 | |
| 6 | 2024 | 2073 | 49 | 17.50 | |
| 7 | 1651 | 1681 | 30 | 10.71 | |
| 8 | 1705 | 1766 | 61 | 21.79 | |
| 9 | 2009 | 2090 | 81 | 28.93 | |
| 10 | 1628 | 1687 | 59 | 21.07 | |
| 11 | 1838 | 1905 | 67 | 23.93 | |
| 12 | 1786 | 1856 | 70 | 25.00 | |
| 13 | 1748 | 1783 | 35 | 12.50 | |
| 14 | 2096 | 2161 | 65 | 23.21 | |
| 15 | 1723 | 1753 | 30 | 10.71 | |
| 16 | 2116 | 2202 | 86 | 30.71 | |
| 17 | 2099 | 2209 | 110 | 39.29 | |
| 18 | 1887 | 1974 | 87 | 31.07 | |
| 19 | 1820 | 1863 | 43 | 15.36 | |
| 20 | 1662 | 1691 | 29 | 10.36 | |

| | |
|---|---|
| Average uptake (L/m3) | 19.5185 |

Two samples were cut up and tested for boric acid equivalent content (BAE).

Using method described previously (pg 17)

Sample 10 uptake weight 59 g
Sample 19 uptake weight 43 g
Sample 10 weight of sample for titration 6.50 g
Sample 18 weight of sample for titration 6.64 g

Using SG of 0.81, average moisture content 11.2% (0.888)

Dilutions of samples 12&16 were weighed, diluted to 100 ml, 10 mls taken and titrated.

Sample 10 titration average was 1.45 mls. This gave a concentration of 0.15% m/m. The m/m % from uptake is 211/m3×0.027 kg/l/400 kg×100=0.14% m/m.

Sample 19 titration average was 0.9 mls. This gave a concentration of 0.096% m/m. The m/m % from uptake is 15.63 l/m3×0.027 kg/l/400 kg×100=0.10% m/m.

Two pieces of 0.075×0.025×0.9 timber were treated with moisture contents of 21% and 22%. The uptakes were 24.3 and 6.9 litres/m3; which indicates the same issues when treating at lower moisture levels.

### Trial Objectives

These trials were set up to demonstrate the upscaling of the borate esters as a means of introducing boron into timber.
To meet the treatment levels of 5% m/m BAE for class 2 (FSI) fire retardancy standard. It would also be possible with harsher treatment cycles to treat to a class I standard.
To meet the level of 1.0% BAE m/m to meet the H2 termite standard.
To meet the 0.4% m/m BAE to meet the H1.2 standard.

Also other issues that have been demonstrated are the ability to have uptakes with less than 10 litres of volatile organics per cubic metre in the final product. These are shown in trials 2 and 4. Another issue faced is the stability of the borate ester with more than one treatment cycle.

Some of the treatment levels were not reached. As the viscosities were high and some of the uptake cycles needed to be changed. These are all prior art. The purpose of the trials was to show that the borate ester has the ability to be used as a carrier to introduce boron into timber at the required commercial levels.

What I claim is:

1. A method of introducing boron as a boron ester into the timber via a non-aqueous liquid medium.

2. Using a borate ester having the formula I:
(RO)₃B
Where R1 may be a C3-C20 alkyl or alkenyl group, R2 is a C3-C20 alkyl or alkenyl group and R3 is a C3-C20 alkyl or alkenyl group. R2 and R3 may form four or five membered ring structures with diols or aminoalcohols to give completely substituted monomeric borates.
